(19) United States
(12) Patent Application Publication
(10) Pub. No.: US 2007/0237889 A1
(43) Pub. Date: Oct. 11, 2007

(54) Method of fabricating full-color OLED arrays on the basis of physisorption-based microcontact printing process wtih thickness control

(75) Inventors: Jung-Wei John Cheng, Chia-Yi (TW); Jeng-Rong Ho, Chia-Yi (TW); Wei-Hsuan Hung, Chia-Yi (TW); Jia-De Jhu, Taipei County (TW); Hsiang-Chiu Wu, Chia-Yi (TW); Wei-Chun Lin, Pingtung County (TW); Wei-Ben Wang, Chia-Yi (TW)

Correspondence Address: BACON & THOMAS, PLLC, 625 SLATERS LANE, FOURTH FLOOR, ALEXANDRIA, VA, 22314, US

(73) Assignee: NATIONAL CHUNG CHENG UNIVERSITY, CHIA-YI (TW)

(21) Appl. No.: 11/727,694

(22) Filed: Mar. 28, 2007

(30) Foreign Application Priority Data
Apr. 6, 2006 (TW) 95112242

(51) Int. Cl. B05D 5/12

(52) U.S. Cl. 427/66

(57) ABSTRACT

A direct and effective method of fabricating full-color OLED arrays on the basis of microcontact printing process is disclosed. The key of the method lies in a physisorption-based microcontact printing process capable of controlling thickness of the printed films. The organic EL materials involved can be of either small or large molecular weights, as long as they are suitable for solution process.

### BACKGROUND OF THE INVENTION

1. Field of the Invention

The present invention relates generally to the fabrication of full-color OLED arrays, and more particularly, to a method of fabricating full-color OLED arrays on the basis of a physisorption-based microcontact printing process capable of thickness control. The organic electroluminescent (EL) materials involved can be of either small or large molecular weights, as long as they are suitable for solution process.

2. Description of the Related Art

The relevant references of prior art are listed below:
[TV87] Tang, C. W.; VanSlyke, S. A.; “Organic electroluminescent diodes,” Appl. Phys, Lett., vol. 51, pp. 913-915, 1987
[BBB90] Burroughes, J. H.; Bradley, D. D. C.; Brown, A. R.; Marks, R. N.; Mackay, K.; Friend, R. H.; Burns, P. L.; Holmes, A. B.; “Light-emitting diodes based on conjugated polymers,” Nature, vol. 347, pp. 539-541, 1990
[FBT00] Forrest, S.; Burrows, P.; Thompson, M.; “The dawn of organic electronics,” IEEE Spectrum, pp. 29-34, September 2000
[CBY98] Chang, S.-C.; Bharathan, J.; Yang, Y.; Helgeson, R.; Wudl, F.; Ramey, M. B.; Reynolds, J. R.; “Dual-color polymer light-emitting pixels processed by hybrid inkjet printing,” Appl. Phys. Lett., vol. 73, pp. 2561-2563, 1998
[WBF03] Wolk, M. B.; Baude, P. F.; Florczak, J. M.; McCormick, F. B.; Hsu, Y.; “Thermal transfer element and process for forming organic electroluminescent devices,” U.S. Pat. No. 6,582,876, June 2003
[HS02] Hoffend, Jr., T. R.; Staral, J. S.; “Thermal mass transfer donor element,” U.S. Pat. No. 6,468,715, October 2002
[CSS01] Chen, J.; Salem, J. R.; Scott, J. C.; “Thermal dye transfer process for preparing opto-electronic devices,” U.S. Pat. No. 6,214,151, April 2001
[ZWW03] Zhuang, Z.; Warren, Jr., L. F.; Williams, G. M.; Cheung, J. T.; “Patterning of polymer light emitting devices using electrochemical polymerization,” U.S. Pat. No. 6,602,395, August 2003
[MFR03] Muller, C. D.; Falcou, A.; Reckefuss, N.; Rojahn, M.; Wiederhirn, V.; Rudati, P.; Frohne, H.; Nuyken, O.; Becker, H.; Meerholz, K.; “Multi-colour-organic light-emitting displays by solution processing,” Nature, vol. 42, pp. 829-833, 2003
[BBH01] Birnstock, J.; Blassing, J.; Hunze, A.; Scheffel, M.; Stobel, M.; Heuser, K.; Wittmann, G; Worle, J.; Winnacker, A.; “Screen-printed passive matrix displays based on light-emitting polymers,” Appl. Phys. Lett., vol. 78, pp. 3905-3907, 2001
[She01] Sheats, J. R.; “Photolithographic processing for polymer LEDs with reactive metal cathodes,” U.S. Pat. No. 6,171,765, January 2001
[KW93] Kumar, A and Whitesides, G. M., “Features of gold having micrometer to centimeter dimensions can be formed through a combination of stamping with an elastomeric stamp and an alkanethiol “ink” followed by chemical etching,”,” Appl. Phys. Lett., vol. 63, pp. 2002-2004, 1993
[BFN02] Breen, T. L.; Fryer, P. M.; Nunes, R. W.; Rothwell, M. E.; “Patterning indium tin oxide and indium zinc oxide using microcontact printing and wet etching,” Langmuir, 18(1); 194-197, 2002
[NLR99] Nuesch, F; Li, Y; and Rothberg, L. J.; “Patterned surface dipole layers for high-contrast electroluminescent displays,” Appl. Phys. Lett., 75(2), 1799-1801, 1999
[KWC00] Koide, Y.; Wang, Q.; Cui, J.; Benson, D. D.; Marks, T. J.; “Patterned luminescence of organic light-emitting diodes by hot microcontact printing (H CP) of self-assembled monolayers,” J. Am. Chem. Soc., 122(45); 11266-11267, 2000
[GNR00] Granlund, T.; Nyberg, T.; Roman, L. S.; Svensson, M.; Inganas, O.; “Patterning of polymer light-emitting diodes with soft lithography,” Adv. Mater, 12, 269-273, 2000
[LZB04] Lee, T.-W.; Zaumseil, J.; Bao, Z.; Hsu, J. W. P.; Rogers, J. A., “Organic light-emitting diodes formed by soft contact lamination,” PNAS (Proc. Of the Nat'l Academy of Sciences of USA), 101(2), 429-433, 2004
[LLW03] Liang, Z.; Li, K.; Wang, Q.; “Direct patterning of poly(p-phenylene vinylene) thin films using microcontact printing,” Langmuir, 19, 5555-5558, 2003

Since the breakthroughs disclosed in [TV87] and [BBB90] in 1987 and 1990 respectively, whether small molecular OLEDs and polymeric OLEDs could be applied to various types of displays has been widely discussed.

FIG. 1A shows a schematic structure of a conventional OLED 100. The OLED 100 has a transparent substrate 102, a transparent anode 104 disposed on the substrate 102, a cathode 108, an organic light emitter 106 sandwiched between said anode 104 and said cathode 108, and an encapsulating layer 110 deposited on said cathode 108 for protecting the organic light emitter 106. The substrate 102 is typically made of glass or transparent plastic. Although only the anode 104 is previously illustrated as being transparent in order to allow light to pass therethrough, the cathode 108 or both the anode and cathode can be transparent. FIG 1B shows detailed structure of the organic light emitter 106. The organic light emitter 106 is composed of, in the order from the cathode 108 to the anode 104, an electron injection layer (EIL) 130, an electron transport layer (ETL) 128, an electroluminescent (EL) layer 126, a hole transport layer (HTL) 124, and a hole injection layer (HIL) 122. Except the EL layer 126, the other layers of the organic light emitters 106 are optional and not absolutely necessary. The crucial feature qualifying an OLED lies in that its EL layer is made of either small organic molecules such as aluminum tris(8-hydroxyquinoline) (Alq3) or large organic polymers such as polyfluorene (PF). The cathode, the anode, and the optional layers of the OLED can be made of either organic or inorganic materials.

Depending upon its drive method, displays made of OLED arrays are classified into two categories, namely, passive matrix displays and active matrix displays. In passive matrix displays, cathodes and anodes are made into parallel columns and arranged orthogonally to each other. FIGS. 2A and 2B illustrate the arrangements of anode and cathode columns respectively. Rows of the anodes 104 are disposed horizontally on the substrate 102 and columns of the cathodes 108 are arranged vertically on an aggregation of the substrate 102, the anode 104, and the organic light emitters 106. (For easy cross-reference, each element of the present invention has a unique numeral reference in the drawings.) The intersection of an anode column and a cathode one defines a pixel which is activated when a positive voltage and a negative (or ground) voltage are applied to the corresponding anode and cathode columns respectively. Instead of applying voltages to a row of anode 104 and a column of cathode 108 in order to drive the pixel defined by the row and column, in active matrix displays, each pixel is driven by an individually addressable drive circuit. As long as each pixel has an individually addressable drive circuit, the anodes and cathodes of the active matrix display can still be arranged in parallel rows and orthogonally, as shown in FIGS. 2A and 2B. Alternatively, one or both of the anode and cathode of each pixel are disposed discretely. FIG. 2C shows an OLED construction with cathodes discretely disposed thereon.

When it comes to making full-color OLEDs, stack and parallel designs are available as indicated in [FBT00]. In stack design, three OLEDs are stacked on one transparent substrate 102, separately emitting red, green, and blue lights to form a single full-color pixel, as shown in FIG. 3A. Elements 302, 304, and 306 are three OLEDs emitting red, green, and blue colors respectively. The sequence of the red, green, and blue OLEDs is subject to user's design. For parallel designs, there are three different approaches. In the first parallel design (FIG. 3B), discrete red, green, and blue OLEDs 302, 304, and 306, are placed side by side on the transparent substrate 102 to form a full-color pixel. In the second parallel design (FIG. 3C), a white light source 350 and three filters 342, 344, and 346 are employed for filtering red, green, and blue lights respectively. The third parallel design (FIG. 3D) utilizes a light source 370, which can emit a light having a constant frequency, and three color-conversion elements 362, 364, and 366 for converting the light of the constant frequency to red, green, and blue lights respectively. The sequence of the red, green, and blue elements in above three parallel designs is subject to user's design.

For fabrication of the OLEDs, a few methods have been adopted or known by the industry. For example, thermal evaporation is the acknowledged choice in the industry for fabrication of small molecular OLEDs. For polymeric OLEDs or small molecular OLEDs suitable for the solution process, two approaches are commonly used, namely, the spin coating approach and inkjet printing method adapted for monochrome OLEDs and full-color OLEDs respectively. However, all of these methods have their limitations or challenges. Because vacuum environment is required, the thermal evaporation method is restricted in nature for fabrication of OLED displays from small size to medium size. The spin coating approach fails to be applied to fabrication of full-color OLEDs because a thin film can only be indiscreetly coated onto the whole substrate without any patterns. The inkjet printing method applied to the fabrication of the full-color OLEDs is a new technology proposed in 1998 as indicated in [CBY98]. Because the organic EL solution is highly evaporative, it is technically challenging for the inkjet printing method to overcome the problems such as easily jammed inkjet head and uneven and non-smooth inkjet-printed organic films.

Because the thermal evaporation method is inefficient in fabrication of large-size OLED displays, the application of the spin coating approach is limited to monochrome displays, and the inkjet printing approach still has not completely overcome the above-mentioned challenges, alternative methods were also developed. The alternative methods capable of directly patterning the EL layer for fabrication of full-color or multi-color OLED displays include thermal transfer as indicated in [WBF03], [HS02], [CSS01], and the references cited therein, electrochemical polymerization as indicated in [ZWW03], photolithography using ultraviolet (UV)-curable EL polymers as indicated in [MFR03], screen printing as indicated in [BBH01], and photolithography using a specially synthesized photoresist as indicated in [She01]. Fabrication of a semi-finished full-color OLED pixel shown in FIG. 4A is taken as an example for brief description of each of these alternative methods as set forth as follows. The semi-finished full-color OLED pixel in FIG. 4A is composed of a substrate 102, an anode layer 104, an HIL layer 122, an HTL 124, and three EL layers 126 (red, green, and blue) situated side-by-side. As mentioned in the beginning, the HIL and HTL layers 122 and 124 are not absolutely necessary in the design of the OLED displays.

FIG. 4B illustrates how to pattern the red, green, and blue EL layers 126 by means of the thermal transfer method. The key factor of the thermal transfer method lies in a donor element. For example, in [WBF03], a donor element 400 is composed of a donor substrate 401, a light-to-heat conversion layer 402, and a transfer layer 403. For application to OLED fabrication, the transfer layer 403 is made of an EL material. With light radiation 406 through a mask 405, a part 404 of the transfer layer 403 made of the EL material departs from the transfer layer 403 due to the heat generated by the light-to-heat conversion layer 402, and is then deposited onto the HTL 124 below the transfer layer 403. Fabrication of the semi-finished full-color OLED is accomplished by repeating the same process for patterning the other two EL layers 126.

FIG. 4C illustrates how the electrochemical polymerization method is applied to OLED fabrication. A patterned anode array 104 on the surface of the substrate 102 is used as the positive electrode and the monomers of the desired EL polymers are dissolved in an electrolyte 412. When a voltage source 416 is applied to the positive electrode and a negative electrode 414, the monomers are oxidized, resulting in positively charged EL polymers formed on the patterned anode array. Afterwards, neutralization of the positively charged polymers can be done optionally. Although the positive charging does not inhibit the EL capability of the polymers, neutralization does greatly enhance the EL performance of the polymers as indicated in [ZWW03]. Since the electrochemical polymerization method requires the positive and negative electrodes, an OLED device fabricated by this method contains neither the HIL layer nor the HTL layer, thus failing to achieve the optimal EL efficiency. Repeating the same process to pattern the other two EL layers will make the semi-finished full-color OLED pixel as desired.

FIG. 4D illustrates how the photolithography method using specially synthesized UV-curable EL polymers is applied to fabrication of full-color OLED devices. The specially synthesized EL polymers are soluble before UV radiation and become cross-linked and insoluble after the UV radiation. For OLED applications, the UV-curable EL polymers are disposed on the HTL 124 by spin coating and exposed to a UV radiation 426 through a mask 424. The parts thereof 422 that are neither cross-linked nor cured are then washed out and a patterned EL layer 126 is created. Repeated applications of the photolithography process give rise to independently patterned red, green, and blue EL layers, accomplishing the desired semi-finished full-color OLED pixel.

FIG. 4E briefly illustrates how to create OLED by the screen printing process. First, a screen 434 made of polyester fabric is placed above the HTL 124 at a predetermined distance which is the so-called snap-off distance 432. Next, a photoresist layer 436 is patterned onto the screen 434 by the photolithography, and then a solution 439 of EL material is disposed onto the screen 434. Finally, a soft rubber squeegee 438 rolls over the solution 439 to force the solution 439 to pass through parts of the screen 434, on which no photoresist is coated, to deposit on the HTL 124. Repeating the screen printing process with properly patterned photoresist layers renders independently printed red, green, and blue EL layers, completing the semi-finished full-color OLED pixel.

FIGS. 4F-4H illustrate how the photolithography method using a new photoresist is applied to fabrication of a full-color OLED through successive photolithographic process. Instead of using UV-curable EL polymers as in the aforementioned photolithography method, the photolithography now employs a specially synthesized photoresist which includes a photoacid generating material and heat-labile monomers as indicated in [She01]. The photoacid generating material releases acid while exposed to light. After the light exposure 442, the photoresist is heated up to a predetermined temperature. The monomers are then cross-linked due to the heat-labile characteristic thereof and the acid released from the photoacid generating material to form a stable polymer. A special feature of this polymer is its solubility in a solvent free of water and active hydrogen. FIG. 4F shows that the photoresist 442 coated on the cathode 444 is under light exposure 448. FIG. 4G shows the outcome that the exposed parts of the photoresist 452 are washed out by the solvent free of water and active hydrogen after heated and cross-lined; reactive ion etching is then applied to remove the unprotected parts of the cathode and the EL layer. The remaining photoresist is removed afterwards, leaving a patterned EL layer covered with a pattern cathode. After creation of the first EL pattern, layers of the EL material of the second type 466, cathode 464, and photoresist 462 are deposited as shown in FIG. 4H. The same photolithography plus etching process is repeated to create a second EL pattern. Repeating the same photolithography to create a third patterned EL layer gives rise to the desired semi-finished full-color OLED pixel.

Reviewing the above alternative methods of fabricating full-color OLED, the thermal transfer method seems to be most feasible, competitive, and mature. Both of the electrochemical polymerization method and the photolithography method using UV curable electroluminescent polymers require specially synthesized EL polymers, consequently, possibly limiting the EL efficiency of the OLED. Another deficiency of the electrochemical polymerization method is its prohibition of the use of the HIL and HTL layers. An OLED without both HIL and HTL layers can only have a sub-optimal EL efficiency. The requirement of reactive ion etching significantly increases the operation cost of the photolithography method using a new photoresist and limits its applications to displays from small size to medium side. As for the screen printing method, there is still much room for improvement in resolution and the on/off current ratio of the fabricated displays.

In addition to the above-mentioned fabrication approaches for multi-color or full-color OLEDs, some promising techniques are also available. Among them, one is directly relevant to this invention, i.e. the microcontact printing (μCP) technique. The μCP method was first reported in a 1993 paper by A. Kumar and G. M. Whitesides as indicated in [KW93]. Its concept is similar to a regular printing process in which a stamp with a designed pattern is used to print ink molecules onto a substrate to create a pattern on the substrate. The μCP method is different from the regular printing process by its stamp, whose raised surfaces are made of materials with very low surface free energy (e.g. poly(dimethylsiloxane), PDMS). The stamps with very low surface free energy greatly facilitates the transfer of the ink molecules onto the substrate, thus, enabling the printing of micron and even nanometer scale patterns. Several attempts to apply μCP to OLED fabrication have been tried as indicated in [BFN02], [NLR99], [KWC01], [GNR00], [LZB04], and [LLW03]. Specifically, [BFN02], [NLR99], and [KWC01] proposed processes using μCP in patterning the anode; [GNR00] discussed a method employing μCP in the patterning of the HTL; and [LZB04] applied the μCP to fabrication of the cathode. [LLW03] studied how to print EL patterns using the μCP by modifying the EL polymer such that the polymer can be adsorbed chemically to a specially selected substrate. Unfortunately, because the EL polymers need specifically modified and the substrate needs to be of the special kind as defined in [LLW03], practical deployment of the proposed method for OLED fabrication poses a great technical challenge.

According to the personal experience of the inventors of the present invention, successfully patterning the EL layer based on the μCP technique has not been disclosed yet probably because of the following two reasons. First, the standard μCP process lacks an effective means for thickness control of the printed patterns. In the standard μCP process, inking the stamp adopts simple methods like pressing against an inking pad, dip-coating, or spraying, resulting in a variation in the thickness of the ink film formed on the stamp in a range from hundreds of nanometers to microns, while optimal thickness of the EL layer falls in 100 nanometers or so with a variation requirement in tens of nanometers. Second, faced with the highly evaporative characteristic of the solvents, like chloroform, required by the organic EL materials, the standard μCP process becomes ineffective in transfer of the EL molecules during the printing.

### SUMMARY OF THE INVENTION

The primary objective of the present invention is to provide a method of fabricating full-color OLED arrays on the basis of microcontact printing process, which effectively overcomes the difficulty of patterning an EL layer.

The foregoing objective of the present invention is attained by the method disclosed hereby, which includes the following steps:

A. Creating a plurality of anodes or cathodes on a substrate;

B. Creating a plurality of multi-layered organic light emitters on the anodes or cathodes created in the step A, wherein each of the light emitters has an organic EL layer created by a new μCP process which includes an inking phase capable of thickness control and a printing phase.

C. Disposing a plurality of cathodes (if what are created in the step A are anodes) or anodes (if what are created in the step A are cathodes) on said organic light emitters created in the step B to accomplish fabrication of said OLED arrays.

### BRIEF DESCRIPTION OF THE DRAWINGS

FIGS. 1A and 1B illustrate the structure of a standard OLED.

FIGS. 2A-2C illustrate alternative arrangements of the anode and cathode in standard OLED arrays with active matrix or passive matrix actuation.

FIGS. 3A-3D illustrate four schemes of single full-color pixel.

FIGS. 4A-4H illustrate conventional fabrication methods of full-color OLED except the thermal evaporation, spin coating, and inkjet printing.

FIGS. 5A-5E illustrate the new μCP process employed in the present invention.

FIGS. 6A-6C illustrate a preferred embodiment of fabrication of a full-color OLED array.

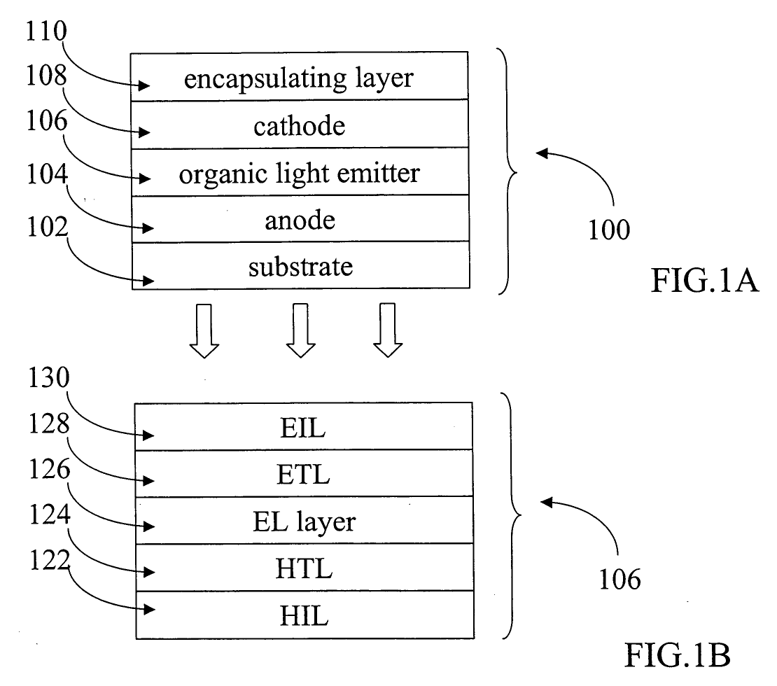

### DETAILED DESCRIPTION OF PREFERRED EMBODIMENTS

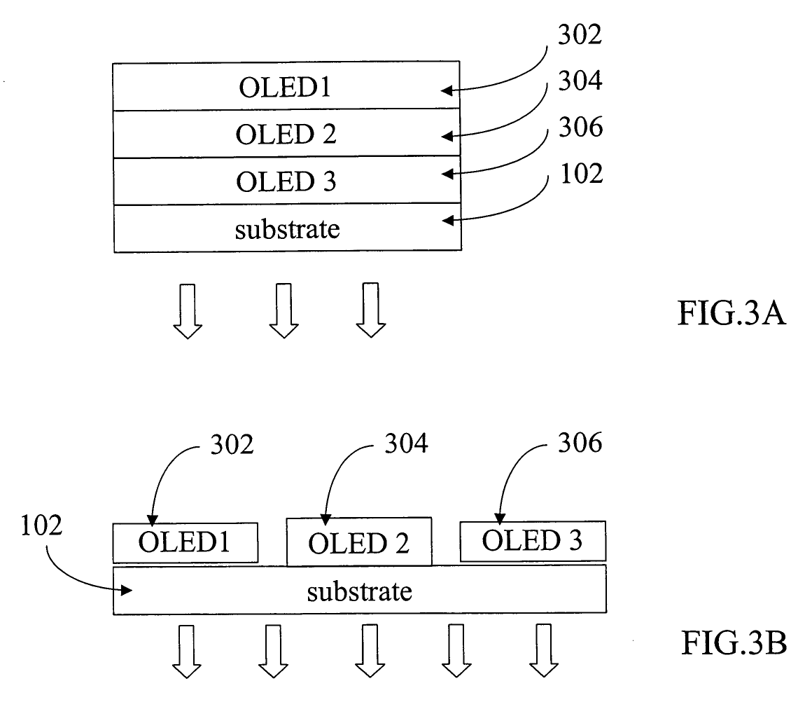

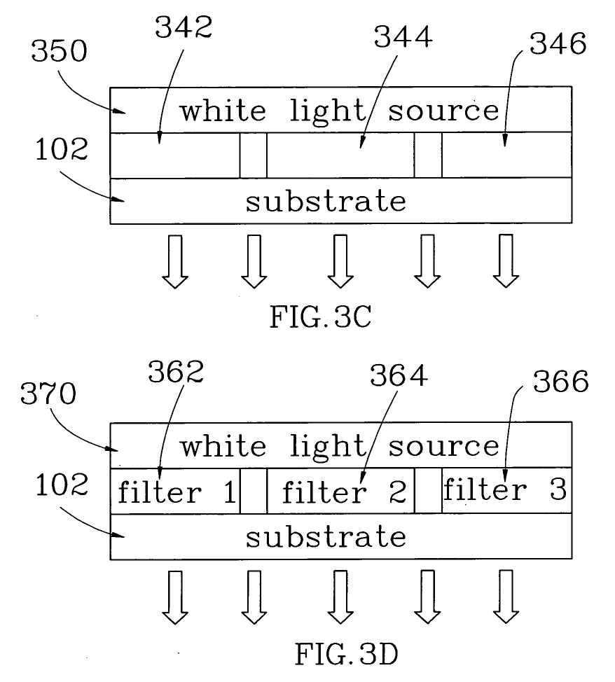

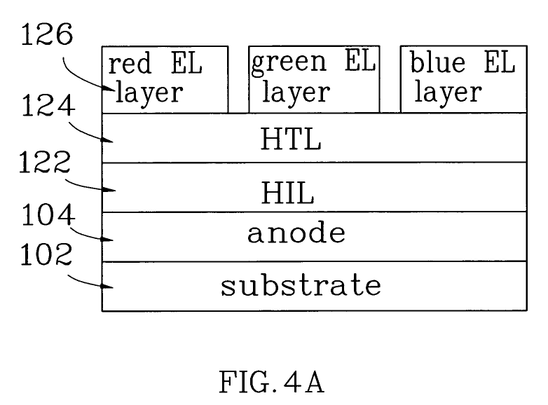

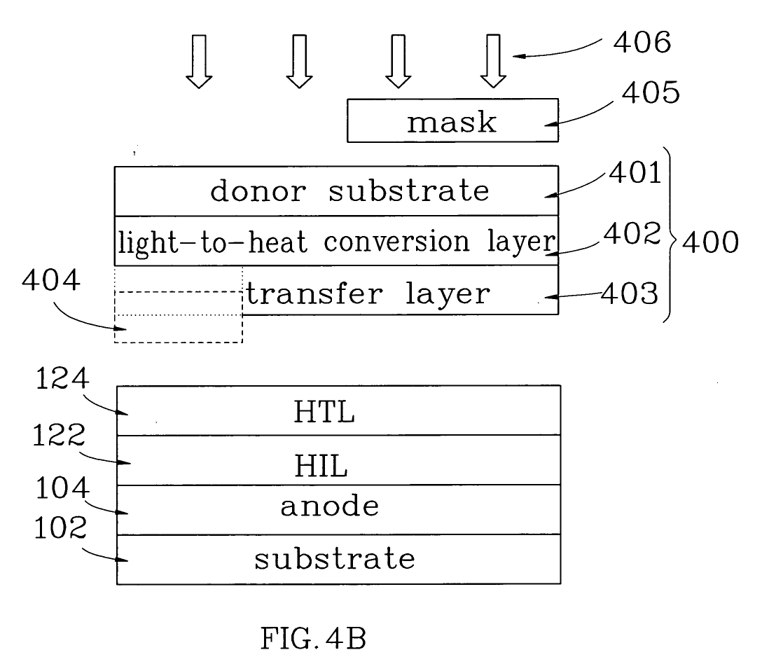

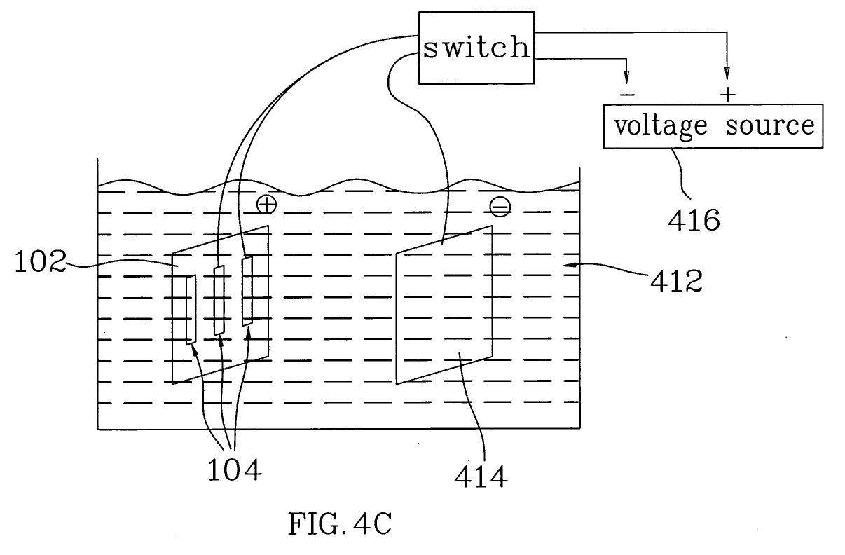

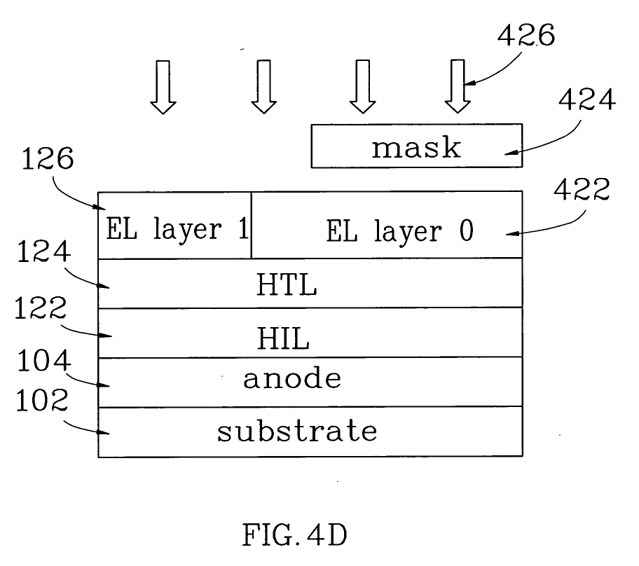

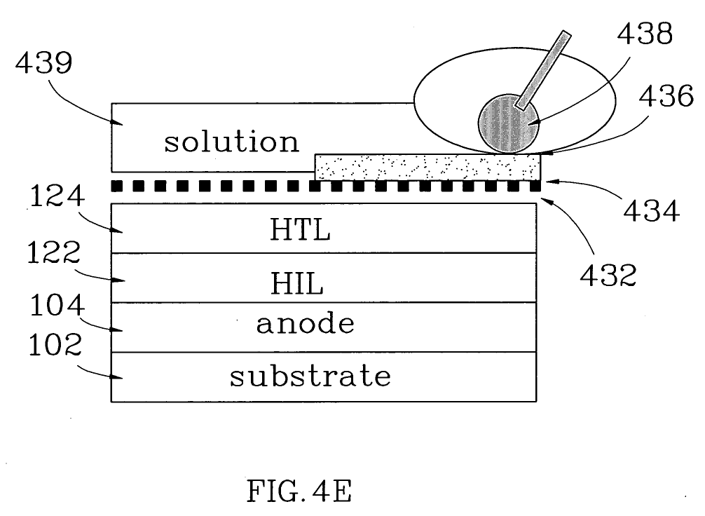

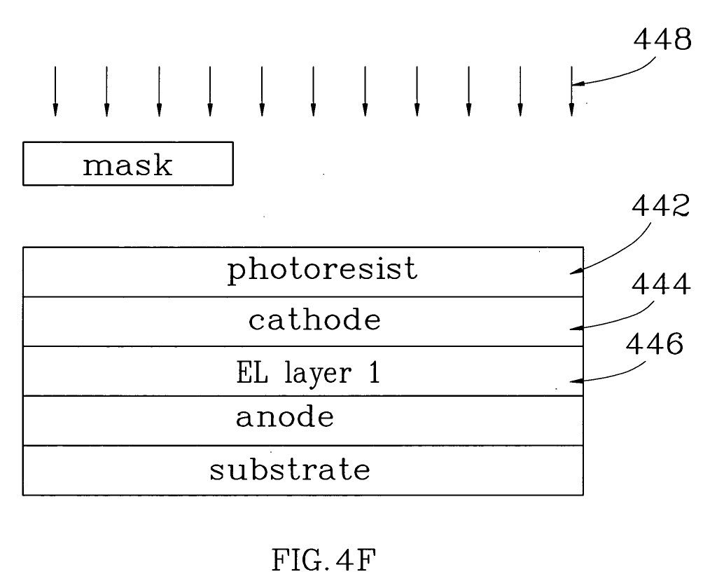

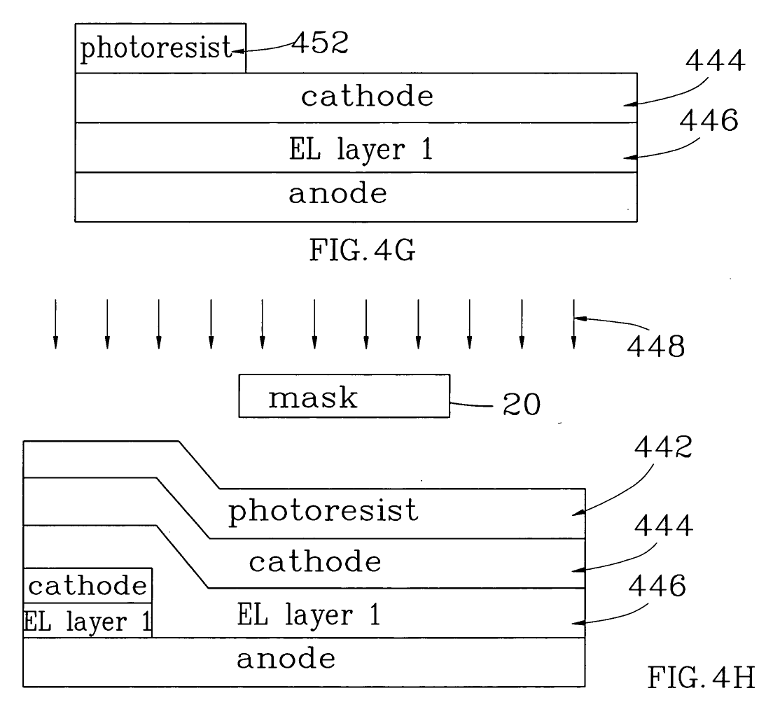

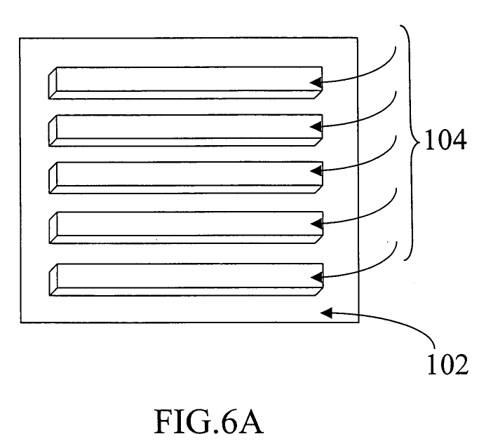

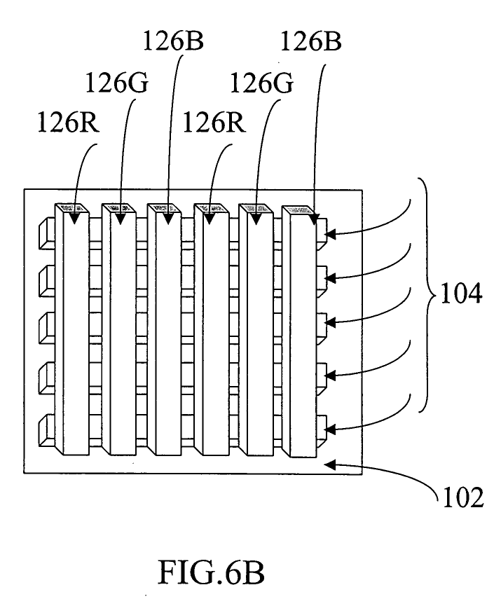

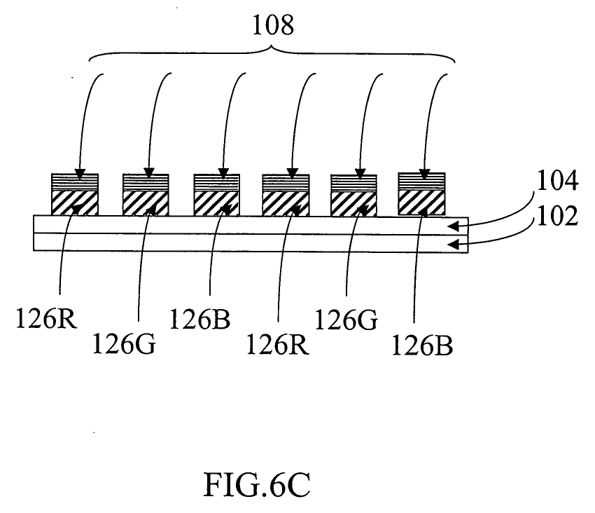

The following preferred embodiment of the present invention depicts fabrication of a full-color OLED array in parallel design as illustrated in FIG. 3B. To avoid tautological recitation, each OLED in the array is assumed to include only the imperative layers, namely, the anode 104, the EL layer 126, and the cathode 108. Referring to FIGS. 6A-6C illustrating how each layer is made, the present invention includes three steps as follows.

A. Disposition of Patterned Anodes.

Create columns of anodes 104 on a substrate 102 by means of any available suitable method, as shown in FIG. 6A. The substrate 102 is a rigid one, like glass, or a flexible one, like transparent polymeric film. Materials that the anode can be made of are not limited to metals, but also include conductive polymers. In addition to conductivity, transparency is another requirement for the materials that the anode is made if the display is designed so that the light is emitted from the anode.

B. Disposition of Organic Light Emitters. (This Step Represents the Heart of the Present Invention.)

Create a plurality of multi-layered organic light emitters on the anodes 104, each of which includes an EL layer 126. Creation of the EL layers 126 is accomplished by employing a new μCP process, including the following two phases: (B1) an inking phase capable of controlling thickness of the ink film deposited on the printing stamp and (B2) a printing phase.

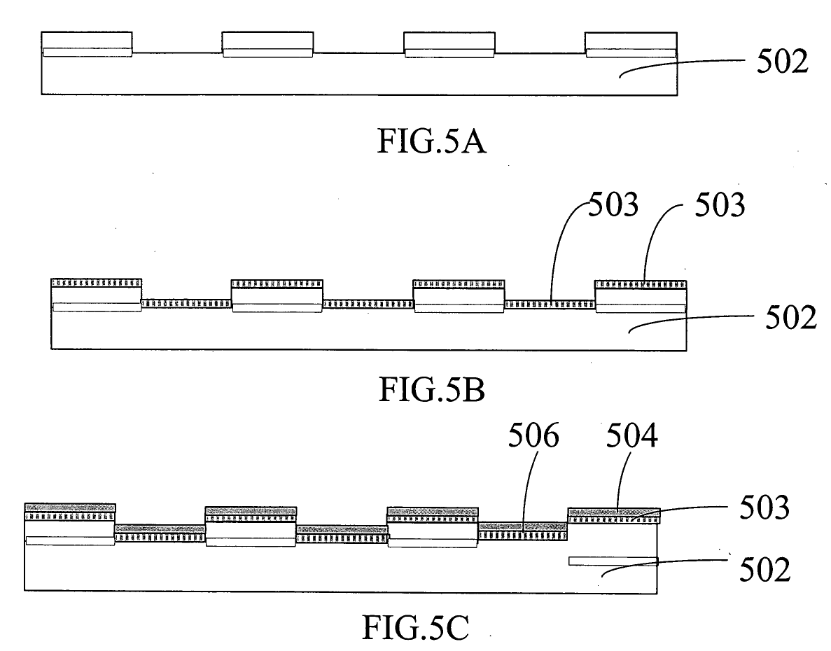

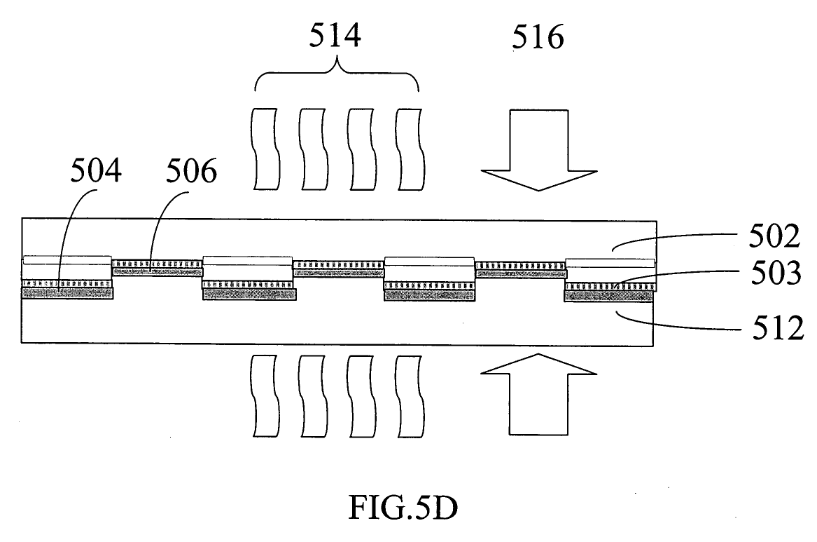

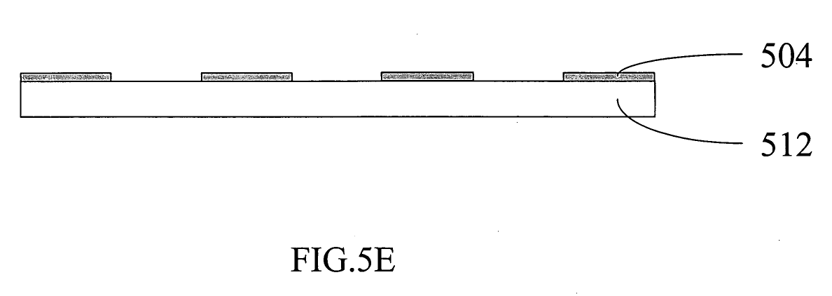

The phase B1 further has two steps, namely, surface wetting and thin-film growth. FIGS. 5A-5C illustrate the inking phase of the new μCP process. The surface-wetting step is optional, depending on the situation. When necessary, the surface-wetting step is aimed at creating a wetting layer on the printing stamp with low surface free energy in order to facilitate successful creation of desired thin film of ink molecules at the next thin-film growth step. FIG. 5A shows a pre-patterned stamp 502. As discussed in the prior art of the standard μCP, the stamp 502 has a characteristic of very low surface free energy. FIG. 5B shows that a wetting layer 503 is formed on the surface of the stamp 502 after the surface wetting step. The wetting layer can be composed of highly evaporative solvent such as toluene or highly reactive functional group generated after a proper treatment on the stamp surface, for example, the hydroxyl, carboxyl, or peroxide generated after the O₂ plasma treatment on the surface of a printing stamp made of PDMS.

FIG. 5C shows a layer of thin-film of ink molecules created on the stamp by a suitable thin-film growth approach, like spin coating as the simplest suitable candidate. Subject to the selected thin-film growth approach, the film of ink may be disposed not only on the raised surfaces of the stamp 502 but also at valleys 506 of the same. As long as the valleys 506 are deep enough, the film at the recessed portions 506 will not affect the transfer of the ink molecules on the raised surfaces during the next printing phase.

The phase B2, as shown in FIG 5D, starts with placing the inked stamp 502 onto a substrate 512, followed by the application of an external heat source 514 with a suitable printing pressure 516 to the stamp 502 and the substrate 512. Application of the external heat and printing pressure is optional. When utilized, the external heat source 514 raises the temperature of the substrate 512 or the stamp 502 and consequently, improves the wetting and adhesive condition between the ink molecules and the substrate. The raised temperature of the substrate 512 or the stamp 502 can be higher or lower than the glass transition temperature of the ink molecules. The externally applied printing pressure 516 increases the effective contact area between the substrate 512 and the film of the ink molecules on the stamp 502, effectively enhancing the transfer of the ink molecules to the substrate. The temperatures of the substrate and stamp and the printing pressure can be adjusted to achieve optimal performance in the transfer of the ink molecules during the printing phase.

After a predetermined printing duration passes, or while a predetermined temperature is reached, or while a predetermined printing pressure is reached, or while a combination of these conditions is met, the printing phase is switched to a demolding phase. In the demolding phase, the temperatures of the substrate and stamp and the downward printing pressure on the stamp are lowered in a coordinated manner according to the P-V-T (pressure-volume-temperature) rheological behavior of the ink molecules in order to effectively reduce the surface roughness and residual internal stress in the final printed film. FIG. 5E shows the final printed film 504 after the demolding phase.

Repeat the aforementioned steps B1 and B2 three times to discretely dispose the red, green, and blue EL layers 126 of a full-color OLED pixel. FIG. 6B shows that the EL layers 126 of vertically interleaved columns of red 126R, green 126G and blue 126B are disposed orthogonally on the columns of anodes 104 by the μCP method. The sequence of red, green, and blue EL columns is design dependent. In addition to the orthogonal arrangement, the EL layers 126 can alternatively be disposed directly on top of the columns of anodes 104.

For performance optimization, the organic light emitters 106 are most likely to include one or more of the ETL 128, EIL 130, HTL 124, and HIL 122 layers. Fabrication of these other layers can be completed by the aforementioned steps B1 and B2 or other available approaches. Except the EL layer 126, these other layers are optional subject to requirement.

C. Disposition of Cathodes.

Dispose the cathodes 108 on the patterned EL layer 126 indicated in step B through available suitable method. The materials that the cathode 108 is made include both metals and conducting polymers. Transparency is also a requirement on the cathode materials if the device is designed to have the light come out from the cathode. Thermal evaporation of the selected cathode material through a mask is the commonest disposition method of the cathodes 108. For solution-based conductive polymers, however, the μCP process of the aforementioned steps B1 and B2 as shown in FIGS. 5A-5E constitutes an effective fabrication method. FIG. 6C shows a sectional view of the full-color OLED array in which the cathodes 108 are disposed.

Furthermore, for the passive matrix OLED arrays, when insulating banks are placed between the EL layers 126 made in the aforementioned step B, the cathode 108 in the step C is not necessarily discretely deposited on top of each EL layer 126, thus allowing for non-directional methods of disposition, such as the direct thermal disposition approach. Placement of the insulating banks between the EL layers 126 can also be completed using the μCP described in the aforementioned steps B1 and B2.

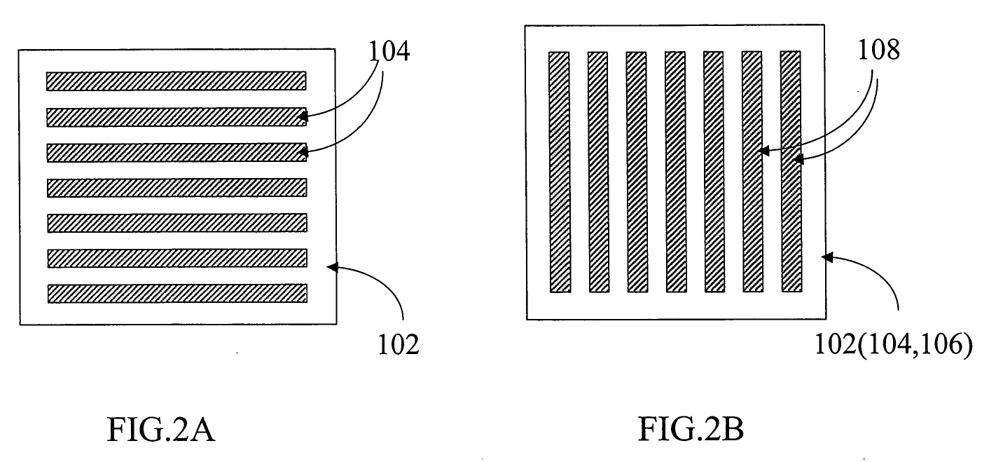

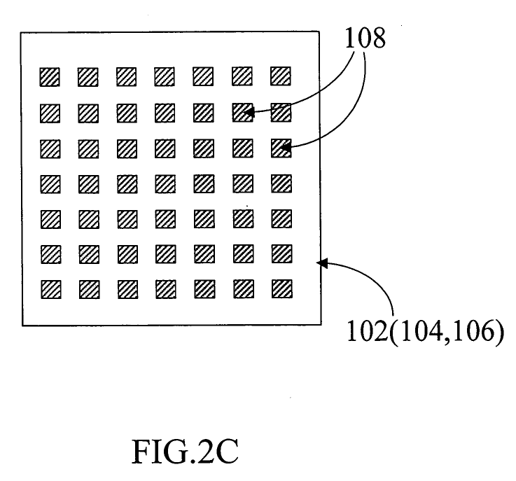

While the present invention has been particularly described as stated above, it will be understood by those skilled in the art that changes to the foregoing in form and detail may be made without departing from the spirit and scope of the present invention. For example, although the aforementioned embodiment was merely concerned with three essential layers including the anode, the EL layer, and cathode, other optional layers such as HIL, HTL, ETL, and EIL can be incorporated into the present invention through any available deposition methods if necessary. It is also feasible to adopt the completely pixelated anodes/cathodes as shown in FIG. 2C in the above embodiment. Further, the preparation sequence of the anodes and the cathodes can be completely converse to that of the aforementioned embodiment. Furthermore, for the purpose of convenient illustration, the parallel design indicated in FIG. 3B is employed in the aforementioned embodiment for generation of full-color pixels. The disclosed invention can also be applied to other full-color pixel designs. While the stack design shown in FIG. 3A is applied for fabrication, the red, green, and blue EL layers can be stacked upon one another in multi-layered disposition in the step B of the aforementioned embodiment. While the second parallel design shown in FIG. 3C is applied, the step B can be adopted for creation of the color filter layers 342, 344, and 346 as well as the EL layer of the white illuminant source 350. While the third parallel design indicated in FIG. 3D is applied, the step B can be employed to create the light conversion layers 362, 364, and 366 and the EL layer of the light source 370.

It is therefore intended that the present invention not be limited to the exact forms and details described and illustrated, but fall within the following claim.

What is claimed is:

1. A method of fabricating full-color OLED arrays on the basis of microcontact printing process, comprising steps of:
A. creating a plurality of anodes or cathodes on a substrate;
B. creating a plurality of multi-layered organic light emitters on the anodes or cathodes created in the step A, wherein each of the light emitters has an organic EL layer created by two phases of:
B1. inking phase capable of controlling desired thickness and
B2. printing phase; and
C. creating a plurality of electrodes, which are cathodes while said anodes are created on said substrate or which are anodes while said cathodes are created on said substrate, on said organic light emitters created in the step B to accomplish fabrication of said OLED arrays.

2. The method as defined in claim 1, wherein in the step A, said anodes or cathodes are parallel or discretely arranged one by one.

3. The method as defined in claim 1, wherein in the step A, said substrate is made of a rigid material like glass or a flexible material like polymeric film.

4. The method as defined in claim 1, wherein in the step A, each of said anodes or cathodes is made of metal or conductive organic material.

5. The method as defined in claim 1, wherein in the phase B1, a film of ink molecules with desired thickness is disposed with a suitable film-growth approach on a pre-patterned or flat printing stamp made of low surface free energy material; while a flat stamp is applied, a further step of patterning must be done after the film of ink molecules grows on said stamp; while it is necessary, before disposing the film of ink molecules with the film-growth approach, a wetting layer having temporary surface wetting potency is disposed on said stamp, like a layer of highly evaporative solvent, to temporarily enhance affinity between the surface of said stamp and said ink molecules.

6. The method as defined in claim 5, wherein in the phase B2, a patterned film disposed on said stamp is transferred onto a substrate by printing; during the printing, while it is necessary, an external heat source or a printing pressure can be applied to said substrate or said stamp in order to enhance the chance of successful transfer of the patterned film.

7. The method as defined in claim 6, wherein in the phase B2, after the surface of the film being transferred is hardened, said stamp can be removed from said substrate; while it is necessary, before said stamp is removed from said substrate, a demolding phase can be additionally provided upon reaching a predetermined printing duration, a predetermined temperature, a predetermined pressure, or a combination of these conditions, during which the externally applied printing pressure and the temperature of the substrate or the stamp are reduced synchronously according to pressure-volume-temperature (P-V-T) rheological behavior of the ink molecules to maintain constant volume of said film while said film is cooled off, whereby after said stamp is removed, the transferred pattern of said film has good surface smoothness and evenness and reduced residual internal stress.

8. The method as defined in claim 1, wherein in the step B, said organic light emitters are composed of multi-layered materials, in which an organic EL layer is essential and, while it is necessary, a plurality of additional layers capable of enhancing performance of said EL layer are disposed on and beneath the EL layer.

9. The method as defined in claim 8, wherein said organic light emitters further comprise an electron transport layer (ETL) and/or an electron injection layer (EIL) disposed on said EL layer, or a hole transport layer (HTL) and/or a hole injection layer (HIL) disposed beneath said EL layer.

10. The method as defined in claim 9, wherein said additional layers can be made according to the step B.

11. The method as defined in claim 8, wherein said organic light emitters comprise parallel columns of red, green, and blue light emitters and easily share said additional layers during their creation.

12. The method as defined in claim 8, wherein said organic light emitters comprise red, green, and blue light emitters stacked upon one another, which sequence depends on design.

13. The method as defined in claim 8 or 11, wherein said organic light emitters are made of suitable color filter materials instead of the organic EL ones for filtering an incident white light into red, green, and blue lights, and a white illuminator made of a suitable EL material is created and disposed on said color filter materials.

14. The method as defined in claim 8 or 11, wherein said organic light emitters are made of light conversion materials instead of the organic EL ones for converting an incident light having a predetermined frequency into red, green, and blue lights, and an organic light emitter capable of emitting said predetermined frequency is created and disposed on said light conversion materials.

15. The method as defined in claim 1, wherein in the step C, said cathodes or anodes are located over said organic light emitters.

16. The method as defined in claim 1, wherein in the step C, said cathodes or anodes are made of metals and disposed by a suitable method like the thermal evaporation through a mask.

17. The method as defined in claim 1, wherein in the step C, said cathodes or anodes are made of conductive organic materials and disposed by a suitable method like the one according to the step B.

18. The method as defined in claim 1 or 15, wherein when said organic EL light emitters in the step B have insulated areas therebetween, said cathodes in the step C is not necessarily located over said light emitters and is disposed by a suitable non-directional method like direct thermal evaporation.
